(19) United States
(12) Patent Application Publication
(10) Pub. No.: US 2004/0191040 A1
(43) Pub. Date: Sep. 30, 2004

(54) Dual truck body

(76) Inventors: Jeffery A. Powell, Lunenburg, MA (US); Steven R. Powell, Lunenburg, MA (US)

Correspondence Address: Timothy A. Johnson, McCormick, Paulding & Huber, LLP, City Place II, 185 Asylum Street, Hartford, CT, 06103, US

(21) Appl. No.: 10/812,180

(22) Filed: Mar. 29, 2004

Related U.S. Application Data
(60) Provisional application No. 60/458,272, filed on Mar. 28, 2003.

(51) Int. Cl. B65F 9/00

(52) U.S. Cl. 414/528

(57) ABSTRACT

According to the present invention, a truck includes a truck body, a partition, a door, a first conveyor system and a second conveyor system. The partition divides the interior volume of the truck body into a first cargo volume and a second cargo volume. The door is located at the rear wall of the truck body and is selectively movable between an open position and a closed position. The first conveyor system is disposed in the first cargo volume and the second conveyor system is disposed in the second cargo volume. The first and second conveyor systems are separately and selectively operable to move materials in the first and second cargo volumes, respectively, towards the door. Therefore, the truck body of the present invention can carry two (2) separate loads of different materials using a single truck in a single trip.

### CROSS REFERENCE TO RELATED APPLICATIONS

This utility application incorporates by reference and claims priority to a prior provisional application filed in the USPTO on Mar. 28, 2003, assigned Serial No. 60/458,272.

### FIELD OF THE INVENTION

The present invention relates to trucks. More specifically, the present invention relates to a truck having a truck body that is partitioned in order to carry two separate loads of different materials simultaneously.

### BACKGROUND OF THE INVENTION

Prior art truck bodies have a single storage area for loading and carrying material. This means that the prior art truck bodies can carry only a single load of material to a user of the material. If the user required two types of materials to be delivered to a job site, the trucks would be required to take two trips back and forth from source to the site in order to meet the user's requirements.

For example, often in the landscaping business, a buyer will purchase from the same supplier both a load of mulch and a load of stone to be delivered to the same address. In many cases, the buyer may be located many miles from the supplier. With prior art truck bodies, the supplier could not deliver both loads at the same time. Rather, the supplier would be forced to make two (2) trips in order to first to deliver the mulch and then to deliver the stone. Alternatively, the supplier would have to use two (2) different trucks to ensure that the two loads do not mix en route. The second trip or the second truck adds to the operating costs of the supplier, as well as increases the wear and tear on the truck(s).

### BRIEF SUMMARY OF THE INVENTION

According to the present invention, a truck includes a truck body, a partition, a door, a first conveyor system and a second conveyor system. The truck body includes an interior volume substantially surrounded by a front wall, a rear wall, and opposing side walls. The partition in the interior volume of the truck body extends from the front wall to the rear wall of the truck body, dividing the interior volume of the truck body into a first cargo volume and a second cargo volume. The door is located at the rear wall of the truck body, and is selectively movable between an open position and a closed position. The door is operable to allow materials from at least one of the cargo volumes to pass therethrough when in the open position. The first conveyor system is disposed in the first cargo volume and the second conveyor system is disposed in the second cargo volume. The first and second conveyor systems are separately and selectively operable to move materials in the first and second cargo volumes, respectively, towards the door.

One advantage of the truck body of the present invention is that it can carry two (2) separate loads of different materials using a single truck, without the need to take separate trips with the same truck or two (2) trucks in a single trip.

Another advantage of the truck body of the present invention is that it can carry two (2) separate loads of different materials in a single trip without mixing the materials of the two loads.

These and other advantages of the present invention will be understood by one of skill in the art in light of the detailed description and drawings.

### BRIEF DESCRIPTION OF THE DRAWINGS

FIG. 1 is perspective view of a dual truck body in accordance with the present invention;

FIG. 2 is a perspective view of one half of the truck body of FIG. 1;

FIG. 3 is a rear view of the truck body of FIG. 1 with the doors closed;

FIG. 4 is a rear view of the truck body of FIG. 1 with the doors open; and

FIG. 5 is a side view of the truck body of FIG. 1.

### DETAILED DESCRIPTION OF THE PREFERRED EMBODIMENTS

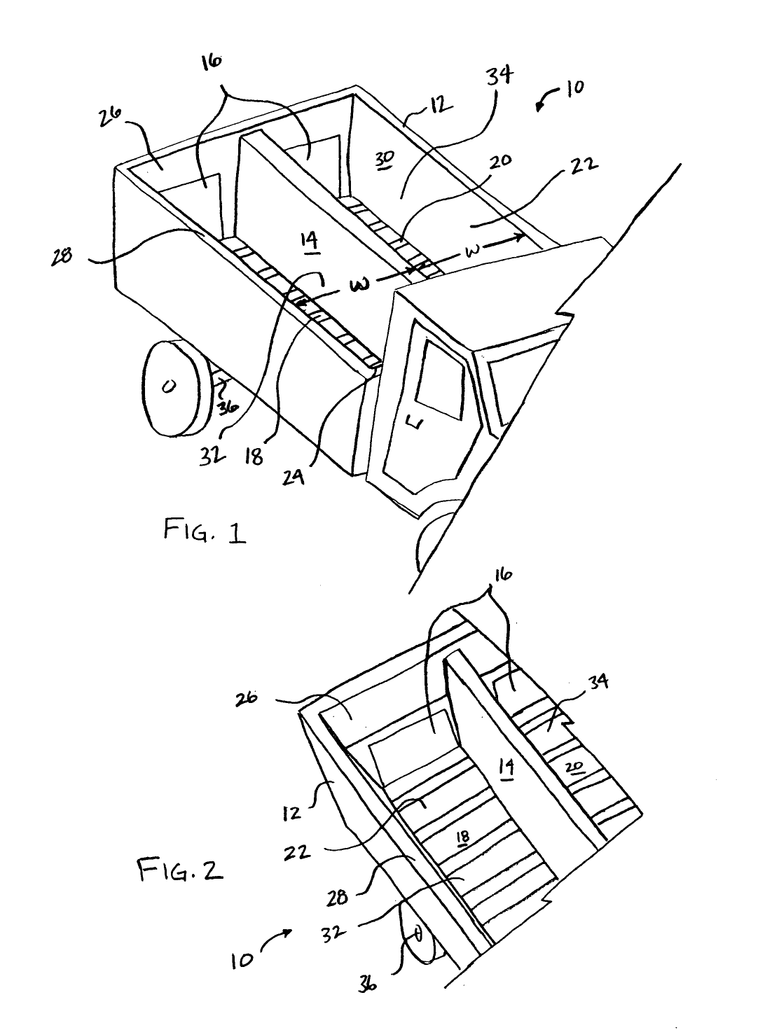

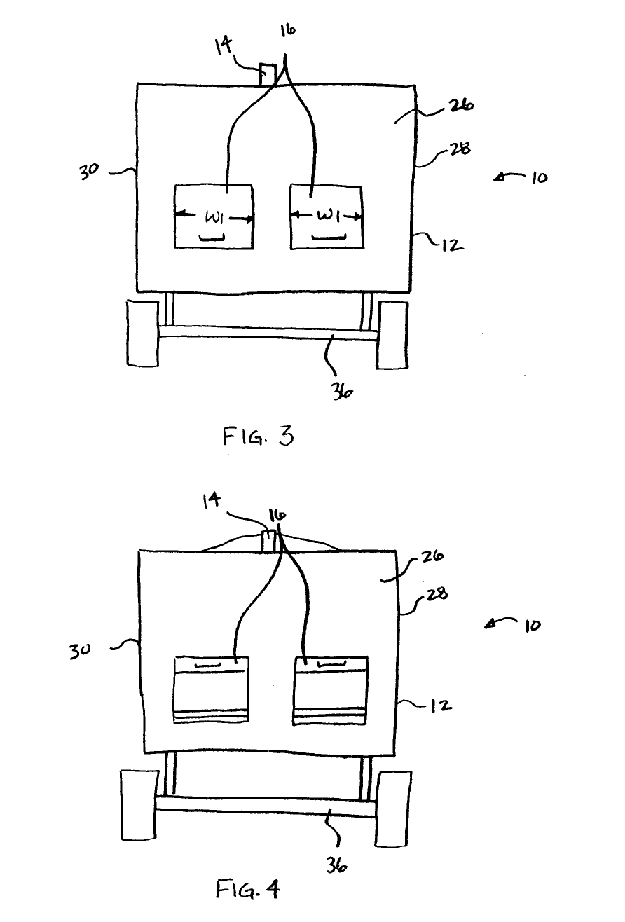

Referring to FIGS. 1 and 2, a truck 10 includes a truck body 12, a partition 14, a door 16, a first conveyor system 18, and a second conveyor system 20. The truck body 12 has an interior volume 22 substantially surrounded by a front wall 24, a rear wall 26, and opposing side walls 28,30.

The interior volume 22 of the truck body 12 includes a partition 14 that separates the interior volume 22 into a first cargo volume 32 and a second cargo volume 34. Typically, each partition 14 extends from the front wall 24 to the rear wall 26 of the truck body 12. Each cargo volume 32,34 includes a conveyor system 18,20. For example, in the embodiment shown in FIG. 1, the first cargo volume 32 and the second cargo volume 34 include a first conveyor system 18 and a second conveyor system 20, respectively. In a preferred embodiment, the partition 14 extends from the front wall 24 to the rear wall 26 of the interior volume 22 approximately midway between the opposing side walls 28,30, resulting in first and second cargo volumes 32,34 of approximately equal width (“W”). However, in some embodiments, the partition 14 may be located closer to one side wall 28,30 than the other, resulting in cargo volumes 32,34 of unequal width (“W”). Additional partitions 14 may also be disposed within the interior volume 22 of the tuck body12, thereby creating additional cargo volumes (not shown).

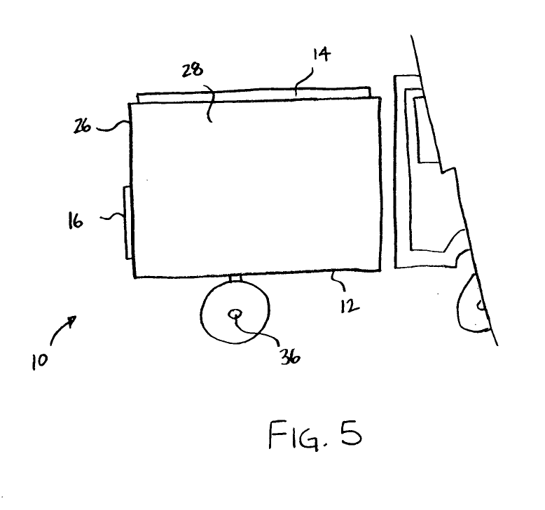

Typically, the partition 14 is taller than the opposing side walls 28,30 and, in some embodiments, is also taller than the rear wall 26 and the front wall 24 as well, as is shown in FIGS. 3, 4 and 5. The partition 14 may be any height taller than the opposing side walls 28,30; however, partitions 14 that are at least twelve inches taller have been found to have particular utility. Because the partition 14 extends from the front wall 24 to the rear wall 26, the user has equal access to both the first and second cargo volumes 32,34. The additional height of the partition 14 enables the user to load materials from one side or the other over either of the opposing side walls 28,30 with, for example a bulldozer, without the materials becoming mixed. The partition 14, in effect, acts as a “back stop” as materials are poured over the side walls 28,30. In addition, the taller partition 14, as shown in FIG. 4, encourages the materials to have a grade where the materials are piled higher near the partition 14 than near the side wall 28,30. Effectively, the weight of the materials is greater in the middle of the truck body 12, than near the side walls 28,30. Therefore, when a truck body 12 contains only a single load, or has already unloaded the materials in one cargo volume 32,34, the weight of the remaining materials is typically near the middle of the truck body 12, thereby preventing the truck 10 from becoming unbalanced or “top heavy.”

Referring to FIG. 2, each conveyor system 18,20 is selectively operable to move the loaded material (not shown), e.g., stone, mulch, loam, or any other type of material, towards the door 16. The conveyor systems 18,20 can utilize a belt, chain or other means to move the material. Each conveyor system 18,20 can operate separately of other conveyor systems present so that the loads of the separate cargo volumes 32,34 can be carried by the same truck body 12 to be unloaded at separate locations.

FIGS. 3, 4, and 5 illustrate rear and side views of the truck body 12 with the doors 16. Each of the doors 16 is selectively movable between a closed position (FIG. 3) and an open position (FIG. 4) and are operable to allow materials from at least one of the cargo volumes 32,34 to pass therethrough when in the open position. Preferably, a door 16 is provided for each of the cargo volumes 32,34 in the interior volume 22 of the truck body 12. For example, in FIG. 1, two (2) doors 16 are present, i.e., one for each of the first and second cargo volumes 32,34, respectively. Each of the doors 16 is located at the rear wall 26. Therefore, the width (“W1”) of each of the doors 16 is oriented generally parallel to and behind the rearmost axle 36 of the truck 10, as shown generally in FIGS. 3, 4 and 5.

One skilled in the art would recognize that the truck body 12 can be built to fit any size truck 10, e.g., one ton or tri-axle size trucks.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A truck, comprising:
a truck body including an interior volume substantially surrounded by a front wall, a rear wall, and opposing side walls;
a partition in the interior volume of the truck body that extends from the front wall to the rear wall of the truck body, the partition dividing the interior volume of the truck body into a first cargo volume and a second cargo volume;
a door located at the rear wall of the truck body, the door being selectively movable between an open position and a closed position and operable to allow materials from at least one of the cargo volumes to pass therethrough when in the open position;
a first conveyor system is disposed in the first cargo volume and a second conveyor system is disposed in the second cargo volume, the first and second conveyor systems being separately and selectively operable to move materials in the first and second cargo volumes, respectively, toward the door.

2. The truck of claim 1, wherein there is at least one door for each separate cargo volume.

3. The truck of claim 1, wherein the truck has a rearmost axle and the door has a width, the width of the door being generally parallel to the rearmost axle of the truck.

4. The truck of claim 1, wherein the partitions extends from the front wall to the rear wall approximately midway between the opposing sides of the truck body.

5. The truck of claim 1, wherein one of the cargo volumes is larger than the other cargo volume.

6. The truck of claim 1 wherein the truck body includes at least a second partition.

7. The truck of claim 1 wherein at least one conveyor system utilizes a belt.

8. The truck of claim 1 wherein at least one conveyor system utilizes a chain.

9. A truck, comprising:
a truck body including an interior volume substantially surrounded by a front wall, a rear wall, and opposing side walls;
a partition in the interior volume of the truck body that extends from the front wall to the rear wall of the truck body, the partition being taller than the opposing side walls, and the partition dividing the interior volume of the truck body into a first cargo volume and a second cargo volume;
a door located at the rear wall of the truck body, the door being selectively movable between an open position and a closed position and operable to allow materials from at least one of the cargo volumes to pass therethrough when in the open position;
a first conveyor system is disposed in the first cargo volume and a second conveyor system is disposed in the second cargo volume, the first and second conveyor systems being separately and selectively operable to move materials in the first and second cargo volumes, respectively, toward the door.

10. The truck of claim 9, wherein there is at least one door for each separate cargo volume.

11. The truck of claim 9, wherein the truck has a rearmost axle and the door has a width, the width of the door being generally parallel to the rearmost axle of the truck.

12. The truck of claim 9, wherein the partitions extends from the front wall to the rear wall approximately midway between the opposing sides of the truck body.

13. The truck of claim 9, wherein one of the cargo volumes is larger than the other cargo volume.

14. The truck of claim 9 wherein the truck body includes at least a second partition.

15. The truck of claim 9 wherein at least one conveyor system utilizes a belt.

16. The truck of claim 9 wherein at least one conveyor system utilizes a chain.

17. The truck of claim 9 wherein the partition is at least twelve inches taller than the opposing side walls.
